(19) United States
(12) Patent Application Publication
(10) Pub. No.: US 2010/0165107 A1
(43) Pub. Date: Jul. 1, 2010

(54) SELF-CONTAINED COVERT SURVEILLANCE SYSTEM

(76) Inventors: John Fred Rix, Tucson, AZ (US); Benjamin Green, Tucson, AZ (US)

Correspondence Address: HAYES SOLOWAY P.C., 3450 E. SUNRISE DRIVE, SUITE 140, TUCSON, AZ, 85718, US

(21) Appl. No.: 12/347,823

(22) Filed: Dec. 31, 2008

(51) Int. Cl. H04N 7/18

(52) U.S. Cl. 348/151; 348/E07.085

(57) ABSTRACT

The present invention provides a self-contained covert surveillance system, comprising an enclosure having an outside appearance resembling a utility box and containing therein at least one camera, a processor, a data storage device, and a means for communications, wherein the enclosure has at least one surface that allows light to penetrate the surface and be captured by the camera. The invention may be further equipped With intake and exhaust fans and/or electric heating and cooling devices to expand the utility of the device to more extreme environmental conditions.

### FIELD OF THE INVENTION

The present invention relates generally to surveillance camera systems. This invention has particular utility for use as covert surveillance systems for rapid deployment in outdoor applications and will be described in connection with such utility, although other utilities are anticipated.

### BACKGROUND OF THE INVENTION

Surveillance systems are widely used to protect property and provide safety. The choice of surveillance system equipment is dependent upon the type of activity being monitored. In some circumstances, it is desirable to make the camera highly visible as a deterrent to the activity targeted by the surveillance system. In other situations however, where the surveillance system is intended to record activities or where the activities may include destruction of property, it may be necessary to design a covert surveillance system. The covert surveillance system thus observes uninhibited activities while protecting the surveillance system from damage due to vandalism.

The prior art includes various examples of covert surveillance systems that have been designed for specific applications. One example provides a surveillance system that can be embedded in common household items such as smoke detectors and clocks. This system, however, is not designed for remote use in outdoor applications. Another prior art example is designed to observe activities from the vantage point of a working street lamp. Both of these examples are limited by the inability to rapidly deploy a self-contained system. See, for example, U.S. Pat. No. 6,249,310; and U.S. Pat. No. 6,624,845.

### SUMMARY OF THE INVENTION

To address the requirements described above, the present invention discloses a self-contained covert surveillance system that is deployable in a wide range of environments. The present invention comprises an enclosure having an outside appearance resembling a utility box and containing therein at least one camera, a processor, a data storage device, and a communication device, wherein the enclosure has at least one surface that allows light to penetrate the surface and be captured by the camera. The invention may be further equipped with intake and exhaust fans and/or electric heating and cooling devices to expand the utility of the device to more extreme environmental conditions.

### BRIEF DESCRIPTION OF THE DRAWINGS

Further features and advantages of the present invention will be seen from the following detailed description, taken in conjunction with the accompanying drawings, wherein

FIGS. 1 and 2 are illustrations of a self-contained covert surveillance system in accordance with the present invention.

### DETAILED DESCRIPTION OF PREFERRED EMBODIMENTS

In the following description, reference is made to the accompanying drawings, which form a part hereof, and in which is shown, by way of illustration, various embodiments of the present invention. It is understood that other embodiments may be utilized and changes may be made without departing from the scope of the present invention.

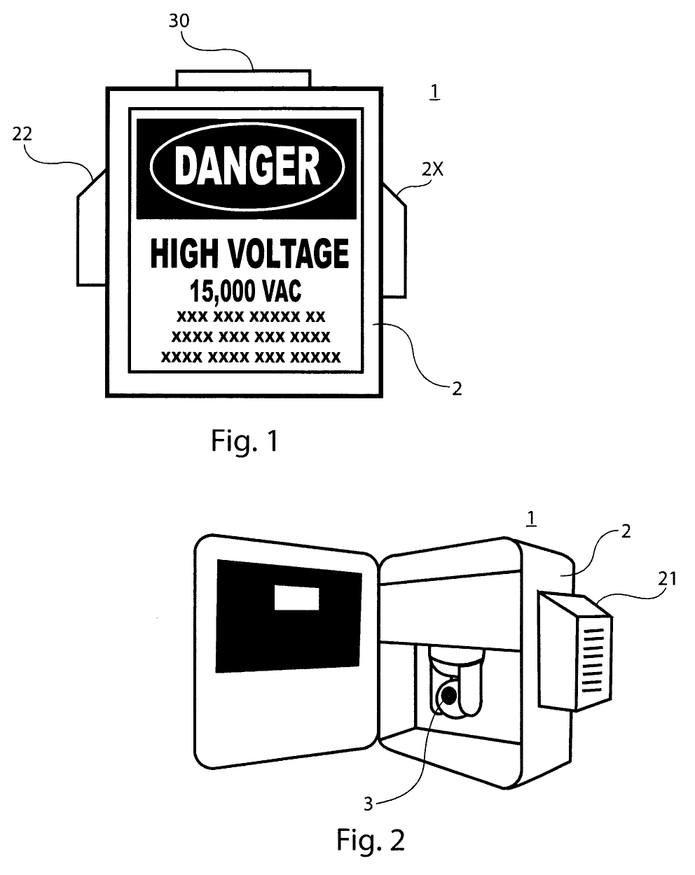

Referring to FIGS. 1-2, the present invention provides a self-contained covert surveillance system 1, comprising an enclosure 2 having the outer appearance of a utility box, wherein at least one surface of the enclosure is semi-transparent, and wherein the enclosure contains at least one camera 3, a processor, a data storage device and a communication system.

As shown in FIG. 1, the enclosure 2, which preferably comprises a weatherproof enclosure, may have the appearance of a high voltage electrical utility box with an optional message displayed thereon discouraging potential vandals from disturbing the contents. Alternatively, the enclosure may have the appearance of any enclosure that would appear in an industrial area or other environment where the present invention would be used, such as for example a control box, a telephone utility box, or other such enclosure. The enclosure is attached to a pole or structure and oriented to allow optimal visibility through the semi-transparent surface.

If desired, the enclosure may include a sound pick-up system, and/or temperature control system for ensuring that the hardware is not subjected to adverse conditions. The temperature control system may include intake and exhaust vents 21, 22 and may also include an electric cooling unit and/or heating unit as desired, and/or heat dissipation fins. The enclosure may be insulated to further the effectiveness of the temperature control system. System preferably is reliable at temperatures ranging from −20° C. to 60° C.

Referring to FIG. 2, the hardware contained in enclosure 2 includes a processor, a camera, hard disk drive (HDD), and communications equipment 27. The enclosure may further contain a battery to eliminate the need for outside power, and/or solar cells 30. The processor, or microprocessor, should be capable of running various operating systems for ease of interfacing with other surveillance systems or surveillance monitoring systems. The HDD should be hot swappable for maximum utility.

The communications system of the present invention may include several options, such as for example, cellular, EVDO, wireless MESH node, point to point, point to multipoint, satellite, and Mesh WiFi. The communications capabilities of the present invention will allow the system to connect to cellular networks, where available, or to connect to locally available wireless networks. The surveillance system may be further equipped With a GPS device to determine the position of the installation.

It should be emphasized that the above-described embodiments of the present device and process, particularly, and “preferred” embodiments, are merely possible examples of implementations and merely set forth for a clear understanding of the principles of the invention. Many different embodiments of the self-contained covert surveillance system described herein may be designed and/or fabricated without departing from the spirit and scope of the invention. For example, the surveillance system of the present invention may be equipped with multiple cameras to view several angles simultaneously. All these and other such modifications and variations are intended to be included herein within the scope of this disclosure and protected by the following claims. Therefore the scope of the invention is not intended to be limited except as indicated in the appended claims.

1. A covert surveillance system, comprising an enclosure having the outside appearance of a utility box, wherein at least one surface of the enclosure is semi-transparent, and wherein the enclosure contains at least one camera, a battery, a processor, a hard disk drive, and a communications device.

2. The system of claim 1, wherein the communications device is one selected from the group consisting of: cellular, EVDO, mesh wireless node, point to point, point to multipoint, satellite, and WiFi.

3. The system of claim 1, wherein the appearance of the enclosure resembles a high voltage electrical box.

4. The system of claim 4, wherein the enclosure is attached to the outer surface of a structure or a pole.

5. A covert surveillance system, comprising a weatherproof enclosure having the outside appearance of a utility box, wherein at least one surface of the enclosure is semi-transparent, and wherein the enclosure contains at least one camera, a processor, a hard disk drive, and a communications device, wherein the enclosure is weatherproof and includes intake and exhaust vents.

6. The system of claim 5, wherein the enclosure further includes an electric cooling unit.

7. The system of claim 5, wherein the enclosure further includes an electric heating unit.

8. The system of claim 5, wherein the enclosure further comprises an insulating layer.

9. The system of claim 5 wherein the communications device is one selected from the group consisting of: cellular, EVDO, mesh wireless node, point to point, point to multipoint, satellite, and WiFi.

10. The system of claim 5, wherein the enclosure is attached to the outer surface of a structure or a pole.

11. The system of claim 5, wherein the enclosure further contains a battery.

12. The system of claim 5, wherein the system further includes a solar cell.
